(19) United States
(12) Patent Application Publication
(10) Pub. No.: US 2013/0039365 A1
(43) Pub. Date: Feb. 14, 2013

(54) ADDRESS TRANSLATION APPARATUS AND COMMUNICATION SYSTEM

(71) Applicant: Atsushi KITADA, Kawasaki (JP)

(72) Inventor: Atsushi KITADA, Kawasaki (JP)

(73) Assignee: FUJITSU LIMITED, Kawasaki-shi (JP)

(21) Appl. No.: 13/534,098

(22) Filed: Jun. 27, 2012

(30) Foreign Application Priority Data
Aug. 12, 2011 (JP) 2011-176778

(51) Int. Cl. H04L 12/56

(52) U.S. Cl. 370/392

(57) ABSTRACT

An address translation apparatus translates an address included in a packet to relay the packet. The packet is transmitted between an external network and an internal network. The address translation apparatus includes a processor. The processor receives a packet transmitted from the internal network. The processor determines, based on a given condition, whether to perform address translation on the received packet. The processor translates, upon determining to perform address translation, a source address of the received packet from an internal address into an external address to obtain a translated packet and relays the translated packet. The processor relays, upon determining not to perform address translation, the received packet to an alternate translation apparatus without performing address translation.

### CROSS-REFERENCE TO RELATED APPLICATION

This application is based upon and claims the benefit of priority of the prior Japanese Patent Application No. 2011-176778, filed on Aug. 12, 2011, the entire contents of which are incorporated herein by reference.

### FIELD

The embodiments discussed herein are related to an address translation apparatus.

### BACKGROUND

Currently, as a measure to continue using Internet Protocol version 4 (IPv4) addresses, the Internet Engineering Task Force (IETF) is examining the use of Large-Scale Network Address Translation (LSN). In the LSN, a Network Address Port Translation (NAPT) function, which is originally provided for broadband routers, is provided for Internet Services Provider (ISP) networks. More specifically, the NAPT function is provided for a router located at a boundary between a core network and an access network. A router located at a boundary between a core network and an access network will be referred to as an “edge router” in the following description.

A user is provided with a private IPv4 address instead of a global IPv4 address, and a global address is shared by a plurality of users, thereby making it possible to reduce the number of global addresses used. A technique is also known in which a plurality of routers that execute Network Address Translation (NAT)/NAPT are provided in a network.

Japanese Laid-open Patent Publication No. 2010-278584 discloses a related technology.

### SUMMARY

According to an aspect of the present invention, provided is an address translation apparatus for translating an address included in a packet to relay the packet. The packet is transmitted between an external network and an internal network. The address translation apparatus includes a processor. The processor receives a packet transmitted from the internal network. The processor determines, based on a given condition, whether to perform address translation on the received packet. The processor translates, upon determining to perform address translation, a source address of the received packet from an internal address into an external address to obtain a translated packet and relays the translated packet. The processor relays, upon determining not to perform address translation, the received packet to an alternate translation apparatus without performing address translation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of a configuration of a communication system;

FIG. 2 is a diagram illustrating an example of a hardware configuration of an edge router;

FIG. 3 is a diagram illustrating an example of a hardware configuration of a first address translation apparatus;

FIG. 4 is a diagram illustrating an example of a hardware configuration of a second address translation apparatus;

FIG. 5 is a diagram illustrating an example of a functional configuration of an edge router;

FIG. 6 is a diagram illustrating a first example of a functional configuration of a first address translation apparatus;

FIG. 7 is a diagram illustrating a first example of a functional configuration of a second address translation apparatus;

FIG. 8 is a diagram illustrating a first example of a process executed by a first address translation apparatus to request a translation process;

FIG. 9 is a diagram illustrating a first example of a process executed by a second address translation apparatus when a translation process has been requested;

FIG. 10 is a diagram illustrating a first example of a process executed by a first address translation apparatus to process a packet;

FIG. 11 is a diagram illustrating an example of a process executed by a second address translation apparatus to process a packet;

FIG. 12 is a diagram illustrating a second example of a functional configuration of a first address translation apparatus;

FIG. 13 is a diagram illustrating a second example of a functional configuration of a second address translation apparatus;

FIG. 14 is a diagram illustrating a second example of a process executed by a first address translation apparatus to process a packet;

FIG. 15 is a diagram illustrating a third example of a functional configuration of a first address translation apparatus;

FIG. 16 is a diagram illustrating a third example of a functional configuration of a second address translation apparatus;

FIG. 17 is a diagram illustrating a second example of a process executed by a first address translation apparatus to request a translation process;

FIG. 18 is a diagram illustrating a second example of a process executed by a second address translation apparatus when a translation process has been requested;

FIG. 19 is a diagram illustrating a fourth example of a functional configuration of a first address translation apparatus;

FIG. 20 is a diagram illustrating a third example of a process executed by a first address translation apparatus to request a translation process;

FIG. 21 is a diagram illustrating a third example of a process executed by a first address translation apparatus to process a packet;

FIG. 22 is a diagram illustrating a fourth example of a process executed by a first address translation apparatus to process a packet;

FIG. 23 is a diagram illustrating a fifth example of a functional configuration of a first address translation apparatus;

FIG. 24 is a diagram illustrating a fourth example of a functional configuration of a second address translation apparatus; and

FIG. 25 is a diagram illustrating a second example of a configuration of a communication system.

### DESCRIPTION OF EMBODIMENTS

A user may comfortably enjoy an Internet Protocol (IP) application service when a reasonable number of ports are used. When a lot of users use the LSN at the same time, available global addresses may temporarily run short, and accordingly a sufficient number of ports are no longer assigned to the users. A strategy in which edge routers having the NAPT function are arranged parallel to one another in each access network in order to tackle the possible shortage of global addresses has a problem in that cost effectiveness decreases because of a reason such as, for example, surplus facilities relative to the amount of traffic.

### 1. First Embodiment

1-1. Configuration of Communication System

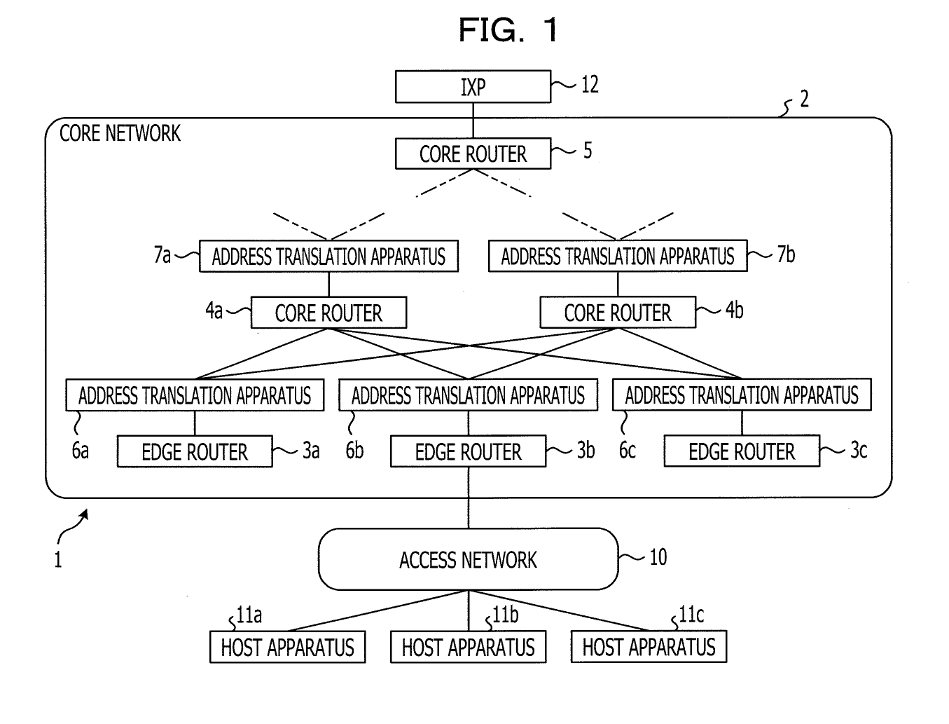

Embodiments will be described hereinafter with reference to the accompanying drawings. FIG. 1 is a diagram illustrating a first example of a configuration of a communication system. A communication system 1 includes a core network 2. The core network 2 includes edge routers 3a to 3c and core routers 4a, 4b, and 5. In the following description, the edge routers 3a to 3c will also be collectively referred to as the “edge routers 3”. The core routers 4a and 4b will also be collectively referred to as the “core routers 4”.

Each of the edge routers 3 is connected to an access network for enabling host apparatuses to access the core network 2. For example, the edge router 3b is connected to an access network 10 to which host apparatuses 11a to 11c are connected. The core router 5 is connected to an Internet exchange point 12. The Internet exchange point is represented as “IXP” in the drawings. With respect to a certain node, which is one of the routers 3, 4, and 5, a node located closer to the internet exchange point 12 than this node will also be referred to as an “upstream node”, and a node located closer to the access network 10 than this node will also be referred to as a “downstream node”. The access network 10, the core network 2, each of the edge routers 3, and each of the core routers 4 are examples of a first network, a second network, a first forwarding apparatus, and a second forwarding apparatus, respectively.

The core network 2 includes first address translation apparatuses 6a to 6c and second address translation apparatuses 7a and 7b. The first address translation apparatuses 6a to 6c may be realized as pieces of hardware separate from the edge routers 3a to 3c, respectively, or may be realized as pieces of hardware integrated with the edge routers 3a to 3c, respectively. For example, the first address translation apparatuses 6a to 6c may be realized as part of the functions of the edge routers 3a to 3c, respectively. Similarly, the second address translation apparatuses 7a and 7b may be realized as pieces of hardware separate from the core routers 4a and 4b, respectively, or may be realized as pieces of hardware integrated with the core routers 4a and 4b, respectively.

The first address translation apparatuses 6a to 6c translate the source addresses of packets forwarded from the access network 10 to the core routers 4 by the edge routers 3a to 3c, respectively, from addresses used in the access network 10 into addresses used in the core network 2. In addition, the first address translation apparatuses 6a to 6c translate the destination addresses of packets forwarded from the core routers 4 to the access network 10 by the edge routers 3a to 3c, respectively, from addresses used in the core network 2 into addresses used in the access network 10.

In response to requests issued from the first address translation apparatuses 6a to 6c, the second address translation apparatuses 7a and 7b translate the source addresses of packets received from the edge routers 3a to 3c by the core routers 4a and 4b from addresses on the access network 10 into addresses on the core network 2. In addition, in response to requests issued from the first address translation apparatuses 6a to 6c, the second address translation apparatuses 7a and 7b translate the destination addresses of packets to be transmitted from the core routers 4a and 4b to the edge routers 3a to 3c from addresses on the core network 2 into addresses on the access network 10.

In the following description, the first address translation apparatuses 6a to 6c will also be collectively referred to as the “first address translation apparatuses 6”. The second address translation apparatuses 7a and 7b will also be collectively referred to as the “second address translation apparatuses 7”. Addresses to be translated herein may include at least any of IP addresses and other pieces of address information such as, for example, the Transmission Control Protocol/User Datagram Protocol (TCP/UDP). In the following description, only processes when address translation from addresses on the access network 10 into addresses on the core network 2 is distributed among the first address translation apparatuses 6 and the second address translation apparatuses 7 will be described. However, address translation from addresses on the core network 2 into addresses on the access network 10 may also be distributed among the first address translation apparatuses 6 and the second address translation apparatuses 7 using the same methods as the processes that will be described later.

Embodiments when addresses used in the core network 2 and the access network 10 are global addresses and private addresses, respectively, will be described hereinafter.

1-2. Hardware Configuration

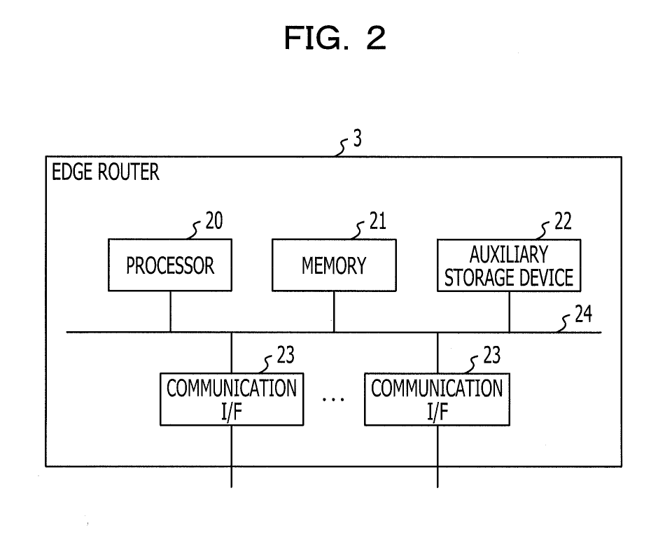

Next, the hardware configuration of each apparatus included in the communication system 1 will be described. FIG. 2 is a diagram illustrating an example of a hardware configuration of an edge router 3. A core router 4 may have the same hardware configuration as the edge router 3. For example, the edge router 3 according to this embodiment is a computer apparatus and includes a processor 20, a memory 21, an auxiliary storage device 22, and communication interfaces 23. These hardware components 20 to 23 are electrically connected to one another by a bus 24. Each interface is represented as “I/F” in the accompanying drawings.

The processor 20 executes various processes for controlling the operation of the edge router 3 and a process for forwarding a packet by executing control programs stored in the auxiliary storage device 22. The memory 21 stores a program that is being executed by the processor 20 and data that is temporarily being used in execution of this program. The memory 21 may be a random-access memory (RAM).

The auxiliary storage device 22 stores a computer program executed by the processor 20, information used to execute this program, and a routing table used for the process for forwarding a packet by the edge router 3. The auxiliary storage device 22 may include a non-volatile memory, a read-only memory (ROM), a hard disk, or the like as a storage device. The communication interfaces 23 are connected to adjacent node apparatuses by communication lines and execute processes on the physical layer and the data link layer for transmitting and receiving packet signals.

The hardware configuration illustrated in FIG. 2 is just one of configurations for realizing the edge routers 3 and the core routers 4. Any other kind of hardware configuration may be adopted insofar as the processes that will be described later are executed.

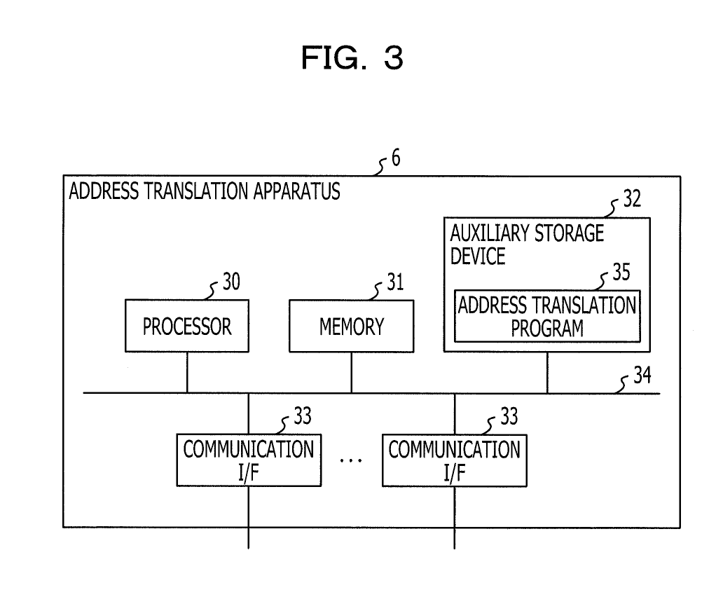

FIG. 3 is a diagram illustrating an example of a hardware configuration of a first address translation apparatus 6. For example, the first address translation apparatus 6 is a computer apparatus and includes a processor 30, a memory 31, an auxiliary storage device 32, and communication interfaces 33. These hardware components 30 to 33 are electrically connected to one another by a bus 34.

The processor 30 executes an address translation program 35 stored in the auxiliary storage device 32 in order to execute information processing for realizing processes executed by the first address translation apparatus 6 that will be described later. The memory 31 stores a program that is being executed by the processor 30 and data that is temporarily being used in execution of this program. The memory 31 may be a RAM.

The auxiliary storage device 32 stores the address translation program 35 executed by the processor 30, information used to execute this program, and an address translation table used for the address translation. The auxiliary storage device 32 may include a non-volatile memory, a ROM, a hard disk, or the like as a storage device. The communication interfaces 33 are connected to adjacent node apparatuses by communication lines and execute the processes on the physical layer and the data link layer for transmitting and receiving packet signals.

The hardware configuration illustrated in FIG. 3 is just one of hardware configurations for realizing the first address translation apparatuses 6. Any other kind of hardware configuration may be adopted insofar as the processes that will be described later are executed.

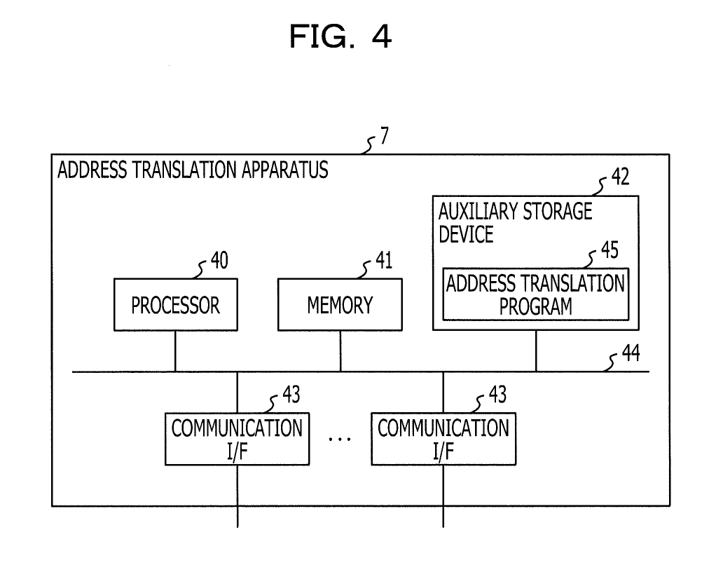

FIG. 4 is a diagram illustrating an example of a hardware configuration of a second address translation apparatus 7. For example, the second address translation apparatus 7 is a computer apparatus and includes a processor 40, a memory 41, an auxiliary storage device 42, and communication interfaces 43. These hardware components 40 to 43 are electrically connected to one another by a bus 44.

The processor 40 executes an address translation program 45 stored in the auxiliary storage device 42 in order to execute information processing for realizing processes executed by the second address translation apparatus 7 that will be described later. The memory 41 stores a program that is being executed by the processor 40 and data that is temporarily being used in execution of this program. The memory 41 may be a RAM.

The auxiliary storage device 42 stores the address translation program 45 executed by the processor 40, information used to execute this program, and an address translation table used for the address translation. The auxiliary storage device 42 may include a non-volatile memory, a ROM, a hard disk, or the like as a storage device. The communication interfaces 43 are connected to adjacent node apparatuses by communication lines and execute the processes on the physical layer and the data link layer for transmitting and receiving packet signals.

The hardware configuration illustrated in FIG. 4 is just one of hardware configurations for realizing the second address translation apparatuses 7. Any other kind of hardware configuration may be used insofar as the processes that will be described later are executed.

1-3. Functional Configuration of Router

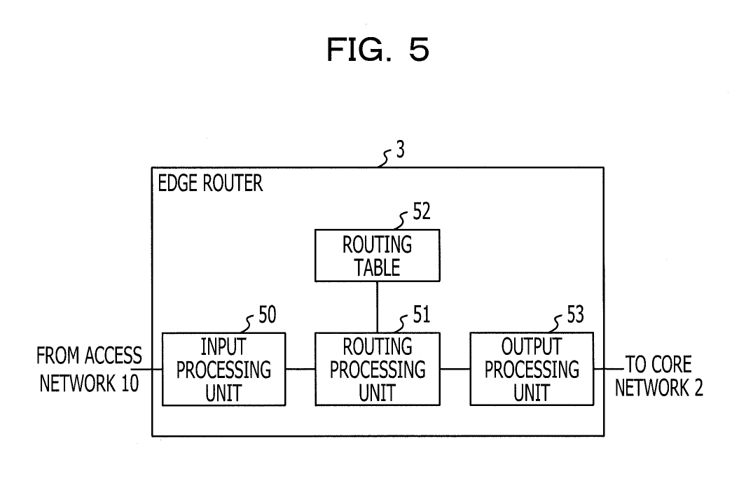

Next, an example of a functional configuration of each apparatus realized by the above-described hardware configurations will be described. FIG. 5 is a diagram illustrating an example of a functional configuration of an edge router 3. FIG. 5 mainly illustrates some of the functional components of the edge router 3 relating to the processes that will be described later herein. The core routers 4 may have the same configuration.

The edge router 3 includes an input processing unit 50, a routing processing unit 51, a routing table 52, and an output processing unit 53. The processor 20 illustrated in FIG. 2 performs information processing in each functional component illustrated in FIG. 5 by executing the program stored in the auxiliary storage device 22 while performing a cooperative operation together with another hardware component in the edge router 3 as appropriate. For example, the information processing in the routing processing unit 51 is executed by the processor 20. The routing table 52 is stored in the auxiliary storage device 22. The processing in the input processing unit 50 and the output processing unit 53 is executed by the communication interfaces 23.

The input processing unit 50 executes a process for receiving a packet from the access network 10. The routing processing unit 51 determines, in accordance with the destination address of the received packet and the routing table 52, an upstream core router 4 to which the packet is to be transmitted next. The output processing unit 53 transmits the packet to the core router 4 determined by the routing processing unit 51 as the destination.

In this embodiment, a packet output from the output processing unit 53 in the edge router 3 is input to the first address translation apparatus 6, and a packet output from the output processing unit 53 in the core router 4 is input to the second address translation apparatus 7. In another embodiment, when the edge router 3 and the first address translation apparatus 6 are integrated with each other, a packet may be directly transmitted to the core router 4 determined by the routing processing unit 51. When the core router 4 and the second address translation apparatus 7 are integrated with each other, a packet may be directly transmitted to a core router 4 as an upstream node determined by the routing processing unit 51.

1-4. Functional Configuration of First Address Translation Apparatus

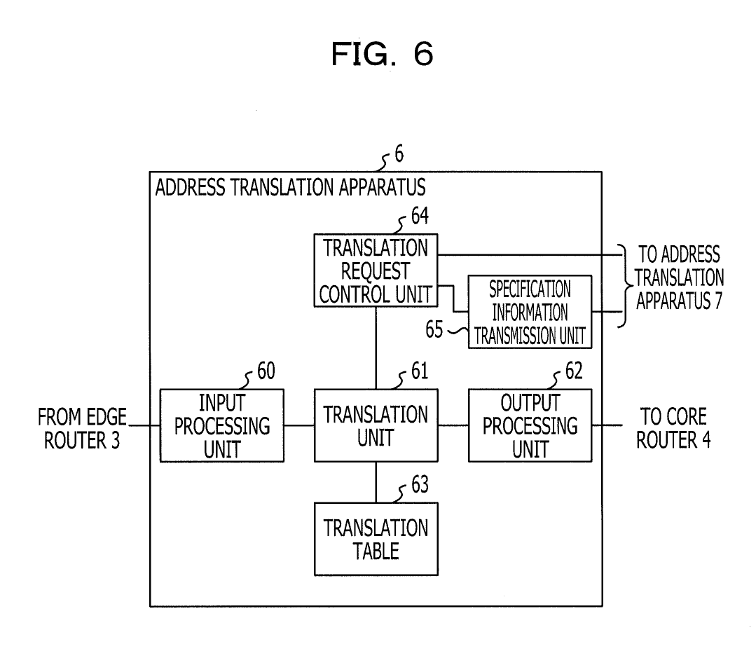

FIG. 6 is a diagram illustrating a first example of a functional configuration of a first address translation apparatus 6. FIG. 6 mainly illustrates some of the functional components of the first address translation apparatus 6 relating to the processes that will be described later.

The first address translation apparatus 6 includes an input processing unit 60, a translation unit 61, an output processing unit 62, a translation table 63, a translation request control unit 64, and a specification information transmission unit 65. The processor 30 illustrated in FIG. 3 performs information processing in each functional component illustrated in FIG. 6 by executing the address translation program 35 stored in the auxiliary storage device 32 while performing a cooperative operation together with another hardware component in the first address translation apparatus 6 as appropriate. For example, the information processing in the translation unit 61, the translation request control unit 64, and the specification information transmission unit 65 is executed by the processor 30. The translation table 63 is stored in the auxiliary storage device 32. The processing in the input processing unit 60 and the output processing unit 62 is executed by the communication interfaces 33.

The input processing unit 60 inputs a packet forwarded from the edge router 3 to the core router 4. The translation unit 61 detects the source address of the packet input from the edge router 3 and translates the source address from a private address into a global address in accordance with the translation table 63. When there is no entry including the detected private address in the translation table 63, the translation unit 61 selects an unused one of global addresses assigned to the edge router 3 as a target address corresponding to the private address. The translation unit 61 registers an entry including the detected private address and the selected global address to the translation table 63. The output processing unit 62 transmits the packet whose source address has been translated into the global address to the core router 4.

In another embodiment, the edge router 3 may include the first address translation apparatus 6. In this case, the process for translating an address executed by the translation unit 61 may be executed after the process executed by the routing processing unit 51, and the input processing unit 60 and the output processing unit 62 may be omitted.

The translation request control unit 64 determines whether or not to request the second address translation apparatus 7 to execute the process for translating a private address into a global address in accordance with the number of addresses registered to the translation table 63. For example, the translation request control unit 64 determines whether or not to request the second address translation apparatus 7 to execute the process for translating an address in accordance with whether or not the number of addresses registered to the translation table 63 satisfies a certain condition. At this time, for example, the translation request control unit 64 may determine whether or not the certain condition is satisfied on the basis of whether or not the number of addresses registered to the translation table 63 exceeds a certain threshold. Alternatively, the translation request control unit 64 may determine whether or not to request the second address translation apparatus 7 to execute the process for translating an address in accordance with the number of empty ports of the global addresses assigned to the edge router 3.

The specification information transmission unit 65 transmits specification information that specifies a private address to be translated by the second address translation apparatus 7 to the second address translation apparatus 7. Various expression modes may be used for the specification information. For example, the specification information may express an address to be translated in the form of an address or, as in the case of a subnet mask, in the form of an address range. When the assignment of addresses to be translated is predetermined between the first address translation apparatus 6 and the second address translation apparatus 7, the specification information transmission unit 65 may be omitted.

As will be described later, the second address translation apparatus 7 transmits a response signal to the first address translation apparatus 6 to accept or reject the request for the process for translating an address. When a response signal for accepting the request is transmitted, the translation request control unit 64 stops the address translation of some or all of the private addresses specified by the specification information that is being executed by the translation unit 61. Thus, some packets are forwarded to the core router 4 without the source addresses thereof, which are the private addresses, being translated.

1-5. Functional Configuration of Second Address Translation Apparatus

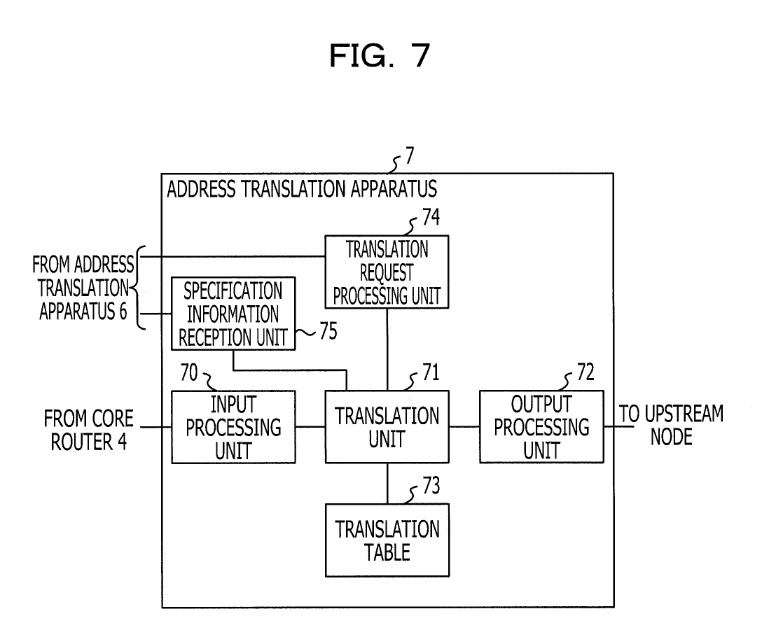

Next, the functional configuration of the second address translation apparatus 7 will be described. FIG. 7 is a diagram illustrating a first example of a functional configuration of a second address translation apparatus 7. FIG. 7 mainly illustrates some of the functional components of the second address translation apparatus 7 relating to the processes that will be described later.

The second address translation apparatus 7 includes an input processing unit 70, a translation unit 71, an output processing unit 72, a translation table 73, a translation request processing unit 74, and a specification information reception unit 75. The processor 40 illustrated in FIG. 4 performs information processing in each functional component illustrated in FIG. 7 by executing the address translation program 45 stored in the auxiliary storage device 42 while performing a cooperative operation together with another hardware component in the second address translation apparatus 7 as appropriate. For example, the information processing in the translation unit 71, the translation request processing unit 74, and the specification information reception unit 75 is executed by the processor 40. The translation table 73 is stored in the auxiliary storage device 42. The processing in the input processing unit 70 and the output processing unit 72 is executed by the communication interfaces 43.

The input processing unit 70 inputs a packet forwarded from the core router 4 to an upstream node. As will be described later, when the translation request processing unit 74 activates an address translation function of the translation unit 71, the translation unit 71 translates the source address of the input packet. The translation unit 71 detects the source address of the input packet and determines whether or not the source address is a private address specified by specification information received from the first address translation apparatus 6. When the source address is a private address specified by specification information, the translation unit 71 translates the source address into a global address in accordance with the translation table 63. When there is no entry including the detected private address in the translation table 73, the translation unit 71 selects an unused one of global addresses assigned to the core router 4 as a target address corresponding to the private address. The translation unit 71 registers an entry including the detected private address and the selected global address to the translation table 73.

The output processing unit 72 transmits, to the upstream node, the packet whose source address has been translated. In another embodiment, the core router 4 may include the second address translation apparatus 7. In this case, the process for translating an address executed by the translation unit 71 may be executed after the process executed by the routing processing unit 51, and the input processing unit 70 and the output processing unit 72 may be omitted.

The translation request processing unit 74 receives a request for the process for translating an address from the first address translation apparatus 6. The translation request processing unit 74 determines whether or not to undertake the process for translating an address by the second address translation apparatus 7, that is, whether to accept or reject the request. For example, the translation request processing unit 74 may determine whether or not to accept the request in accordance with the number of addresses registered to the translation table 73. Alternatively, the translation request processing unit 74 may determine whether or not to accept the request in accordance with the number of empty ports of the global addresses assigned to the core router 4.

When the request is to be accepted, the translation request processing unit 74 transmits a response for accepting the request to the first address translation apparatus 6. In addition, the translation request processing unit 74 changes the setting of the translation unit 71 such that the address translation function becomes active. The specification information reception unit 75 receives the specification information from the first address translation apparatus 6 and transmits the received specification information to the translation unit 71. When the request is to be rejected, the translation request processing unit 74 transmits a response for rejecting the request to the first address translation apparatus 6.

1-6. Processes for Requesting Translation Process

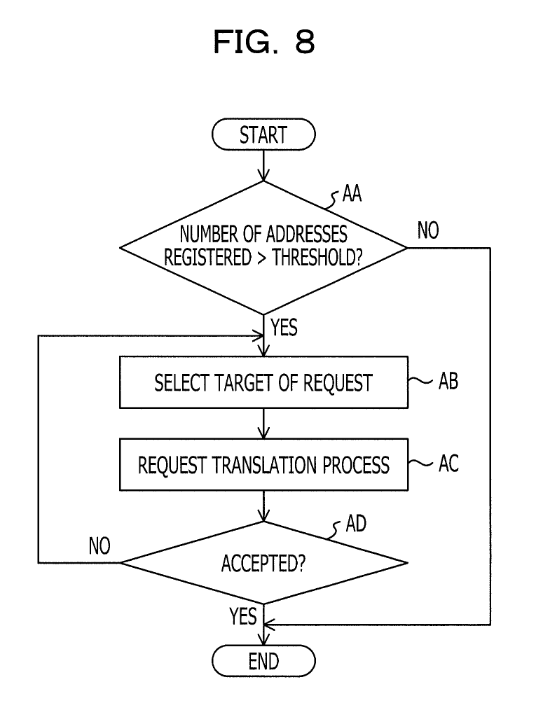

Next, processes executed by the first address translation apparatus 6 and the second address translation apparatus 7 will be described. First, a process executed by the first address translation apparatus 6 to request the second address translation apparatus 7 to execute the process for translating an address will be described. FIG. 8 is a diagram illustrating a first example of a process executed by a first address translation apparatus 6 to request the process for translating an address.

In AA, while monitoring the number of addresses registered to the translation table 63, the translation request control unit 64 determines whether or not to request the second address translation apparatus 7 to execute the process for translating an address in accordance with the number of addresses registered to the translation table 63. For example, the translation request control unit 64 determines whether or not the number of addresses registered to the translation table 63 exceeds a certain threshold. The process proceeds to AB when the process for translating an address is to be requested (YES in AA). When the process for translating an address is not to be requested (NO in AA), the process ends.

In AB, the translation request control unit 64 selects one of second address translation apparatuses 7 that translate addresses of packets transmitted by core routers 4 located adjacent to edge routers 3 as a target requested to execute the process for translating an address.

In AC, the translation request control unit 64 transmits a request for the process for translating an address to the selected second address translation apparatus 7. The translation request control unit 64 also transmits the specification information to the selected second address translation apparatus 7.

In AD, the translation request control unit 64 determines whether the request is accepted or rejected on the basis of a response from the second address translation apparatus 7. When the request is accepted (YES in AD), the translation request control unit 64 stops the address translation, which is being executed by the translation unit 61, for some or all of private addresses specified by the specification information. The process ends thereafter. The process returns to AB when the request is rejected (NO in AD). Then, AB to AD are repeated in which another second address translation apparatus 7 is selected.

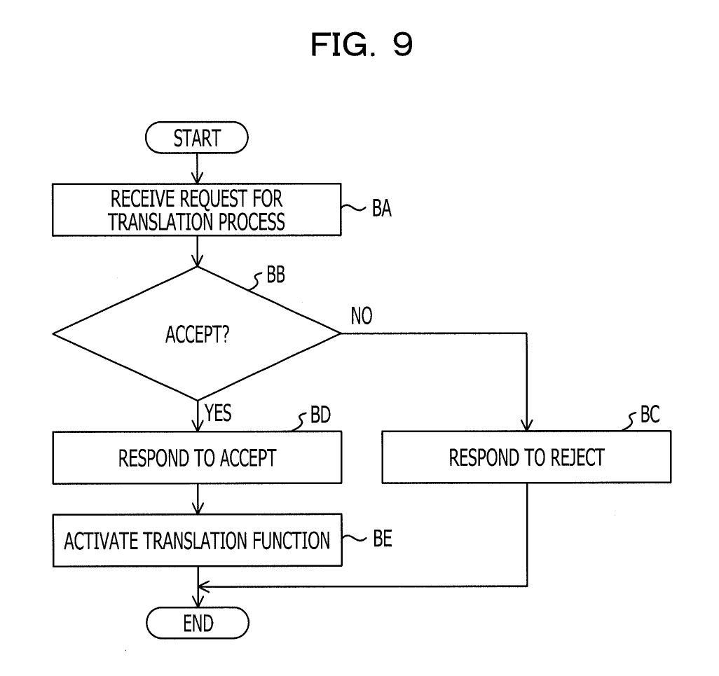

FIG. 9 is a diagram illustrating a first example of a process executed by a second address translation apparatus 7 upon receiving the request for the process for translating an address.

In BA, the translation request processing unit 74 receives the request for the process for translating an address from the first address translation apparatus 6.

In BB, the translation request processing unit 74 determines whether or not to accept the process for translating an address by the second address translation apparatus 7, that is, whether to accept or reject the request. The process proceeds to BD when accepting the request (YES in BB). The process proceeds to BC when rejecting the request (NO in BB).

In BC, the translation request processing unit 74 transmits a response for rejecting the request to the first address translation apparatus 6.

In BD, the translation request processing unit 74 transmits a response for accepting the request to the first address translation apparatus 6. The specification information reception unit 75 receives the specification information from the first address translation apparatus 6 and transmits the received specification information to the translation unit 71.

In BE, the translation request processing unit 74 activates the address translation function of the translation unit 71.

1-7. Processing on Packet

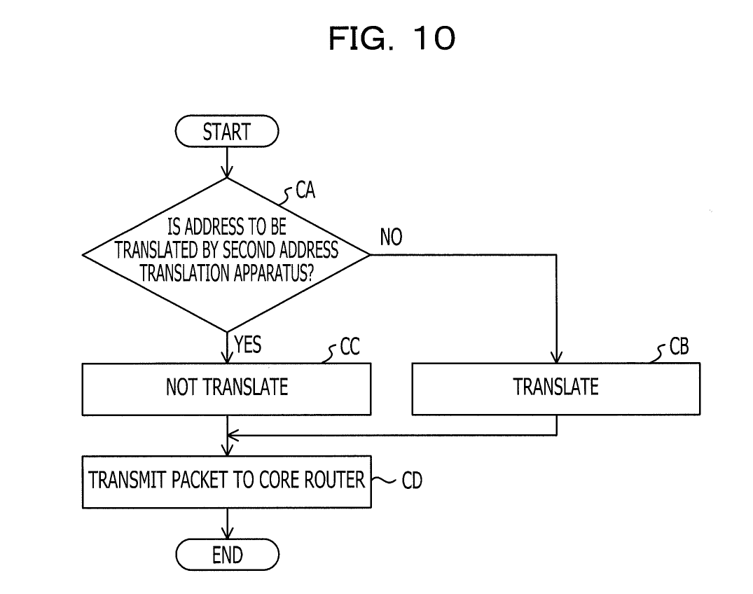

Next, a process for processing the source address of a packet will be described. FIG. 10 is a diagram illustrating a first example of a process executed by the first address translation apparatus 6 to process a packet.

In CA, the translation unit 61 determines whether or not the source address of a packet input from the edge router 3 corresponds to an address to be translated by the second address translation apparatus 7 specified by the specification information. When the source address corresponds to an address to be translated by the second address translation apparatus 7 (YES in CA), the process proceeds to CC. When the source address does not correspond to an address to be translated by the second address translation apparatus 7 (NO in CA), the process proceeds to CB.

In CB, the translation unit 61 translates the source address from a private address into a global address in accordance with the translation table 63. The process then proceeds to CD.

On the other hand, in CC, the translation unit 61 does not translate the source address of the input packet. The process then proceeds to CD.

In CD, the output processing unit 62 transmits the input packet to the core router 4.

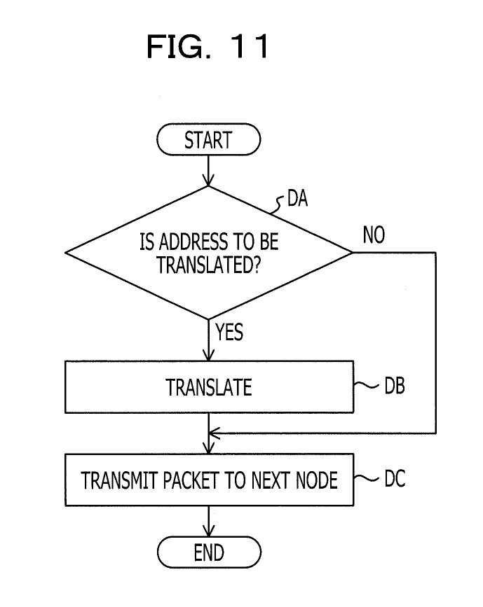

FIG. 11 is a diagram illustrating an example of a process executed by the second address translation apparatus 7 to process a packet.

In DA, the translation unit 71 determines whether or not the source address of the packet input from the core router 4 corresponds to a private address to be translated specified by the specification information. When the source address is an address to be translated (YES in DA), the process proceeds to DB. When the source address is not an address to be translated (NO in DA), the process proceeds to DC.

In DB, the source address is translated from a private address into a global address in accordance with the translation table 73. The process then proceeds to DC.

In DC, the output processing unit 72 transmits the input packet to a core router as an upstream node.

According to this embodiment, the process for translating an address executed at the positions of the edge routers 3 are also executed at the positions of the respective adjacent core routers 4 along paths from the edge routers 3 in a distributed manner. By executing the address translation in components other than the edge routers 3 and therefore by increasing the number of addresses that may be translated, it is possible to reduce the number of edge routers 3 to be newly provided relative to an increase in the number of global addresses used.

In addition, according to this embodiment, it is possible to determine whether or not to execute the process for translating an address at the positions of the core routers 4 in accordance with the number of entries while monitoring the number of addresses, that is, the number of entries, registered to the translation table for the address translation executed at the positions of the edge routers 3. Thus, by distributing the process for translating an address to the core routers 4 when global addresses are temporarily running short in the edge routers 3, it is possible to avoid a problem in that a lot of edge routers 3 are provided to tackle the temporary shortage and in that cost effectiveness decreases.

In addition, according to this embodiment, each second address translation apparatus 7 arranged at the position of each core router 4, which is an upstream node, may be shared by a plurality of first address translation apparatuses 6. That is, when global addresses have temporarily run short in the plurality of first address translation apparatuses 6, part of the process for translating an address that is being executed by these first address translation apparatuses 6 may be distributed to a single second address translation apparatus 7. Therefore, cost effectiveness further improves compared to when edge routers 3 are newly provided.

In another embodiment, the second address translation apparatus 7 may include an address determination unit that determines whether or not the source address of an input packet that is to be forwarded from the core router 4 to an upstream node is a private address when the packet has been input. The address determination unit may activate the address translation function of the translation unit 71 when the source address of the input packet is a private address. In this case, the request to the second address translation apparatus 7 for the process for translating an address made by the translation request control unit 64 in the first address translation apparatus 6 and the response from the translation request processing unit 74 in the second address translation apparatus 7 may be omitted. The transmission of the specification information by the specification information transmission unit 65 may also be omitted.

### 2. Second Embodiment

Next, a second embodiment will be described. In the first embodiment, a packet whose source address is to be translated by the second address translation apparatus 7 is specified by the specification information. In this embodiment, a packet whose source address is to be translated by the second address translation apparatus 7 is specified by an identifier added to the packet. Components and functions thereof included in this embodiment may be included in other embodiments that will be described later.

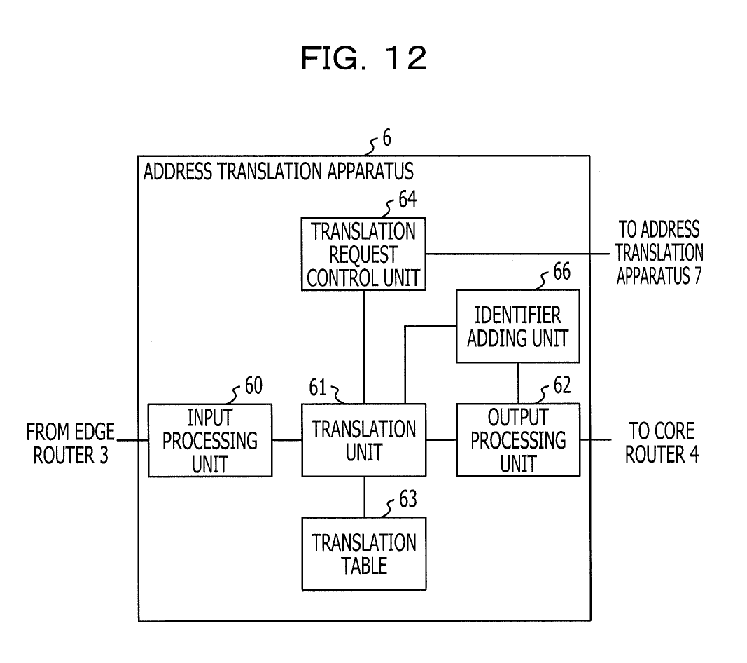

FIG. 12 is a diagram illustrating a second example of a functional configuration of the first address translation apparatus 6. The first address translation apparatus 6 includes an identifier adding unit 66. The translation unit 61 determines whether or not the source address of an input packet corresponds to a private address to be translated by the second address translation apparatus 7. The translation unit 61 transmits a result of the determination to the identifier adding unit 66. When the source address corresponds to an address to be translated by the second address translation apparatus 7, the identifier adding unit 66 instructs the output processing unit 62 to add a certain identifier to the packet. The identifier may be stored in a Layer 2 (L2) frame header and may be, for example, a virtual local area network (VLAN) identifier.

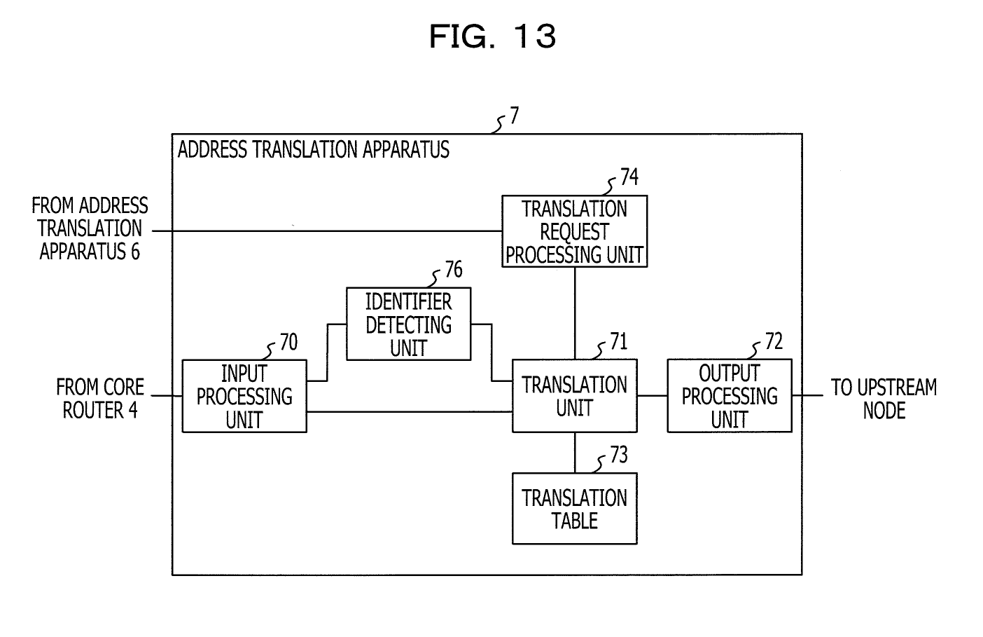

FIG. 13 is a diagram illustrating a second example of a functional configuration of the second address translation apparatus 7. The second address translation apparatus 7 includes an identifier detecting unit 76. The identifier detecting unit 76 detects, in an input packet, an identifier added by the identifier adding unit 66. The translation unit 71 determines whether or not to translate the source address into a global address in accordance with whether or not an identifier has been detected.

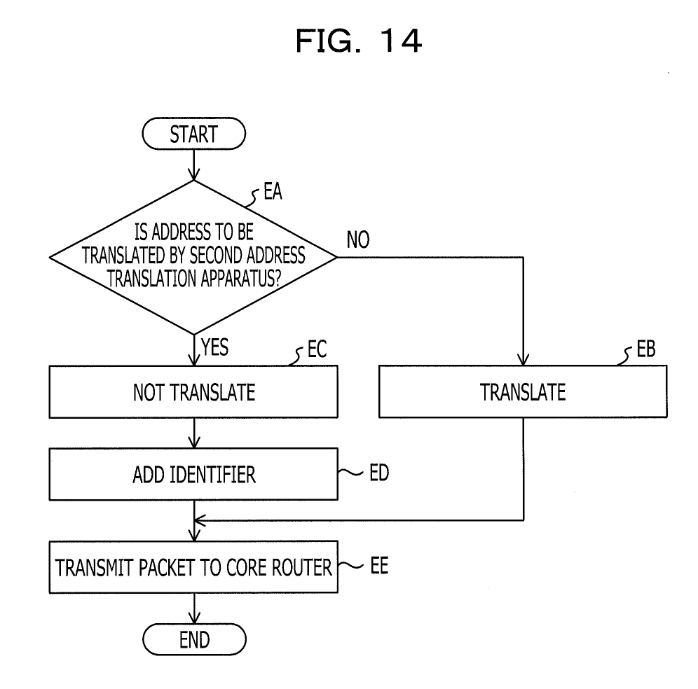

FIG. 14 is a diagram illustrating a second example of a process executed by the first address translation apparatus 6 to process a packet. EA to EC and EE are the same as CA to CC and CD, respectively, illustrated in FIG. 10.

In ED, the identifier adding unit 66 instructs the output processing unit 62 to add a certain identifier to the packet. The output processing unit 62 adds the certain identifier to the packet.

In EE, the output processing unit 62 transmits the packet to the core router 4.

According to this embodiment, the first address translation apparatus 6 may check the source address of each packet against addresses to be translated by the second address translation apparatus 7. Therefore, because the amount of processing executed by the second address translation apparatus 7 is reduced, it becomes easier to apply this embodiment to an existing core router 4.

### 3. Third Embodiment

Next, a third embodiment will be described. A first address translation apparatus 6 according to this embodiment transmits, to a second address translation apparatus 7 or a core router, reachability information of a response packet output in response to a packet for which the first address translation apparatus 6 has requested the second address translation apparatus 7 to execute the process for translating an address. The reachability information refers to path information for making it possible for the response packet output in response to the packet to be translated by the second address translation apparatus 7 to reach the edge router 3. Components and functions thereof included in this embodiment may be included in other embodiments that will be described later.

When the source address of a packet forwarded from the edge router 3 to the core router 4 is to be translated by the second address translation apparatus 7, the source address is a private address. Therefore, when a response packet has been sent back, the second address translation apparatus 7 returns the destination address to the private address. However, since a global address is used for a routing process in the core network 2, the core router 4 does not know the destination of the response packet. Therefore, the reachability information is transmitted to the second address translation apparatus 7 or the core router 4. After receiving the reachability information, the second address translation apparatus 7 or the core router 4 registers the path information based on the reachability information to the routing table in the core router 4.

The reachability information transmitted from a first address translation apparatus 6b may be, for example, path information that specifies an edge router 3b as a next hop of a packet whose destination is an address used in the access network 10 connected to the first address translation apparatus 6b. The address used in the access network 10 may be, for example, the network address of the access network 10 or a subordinate network.

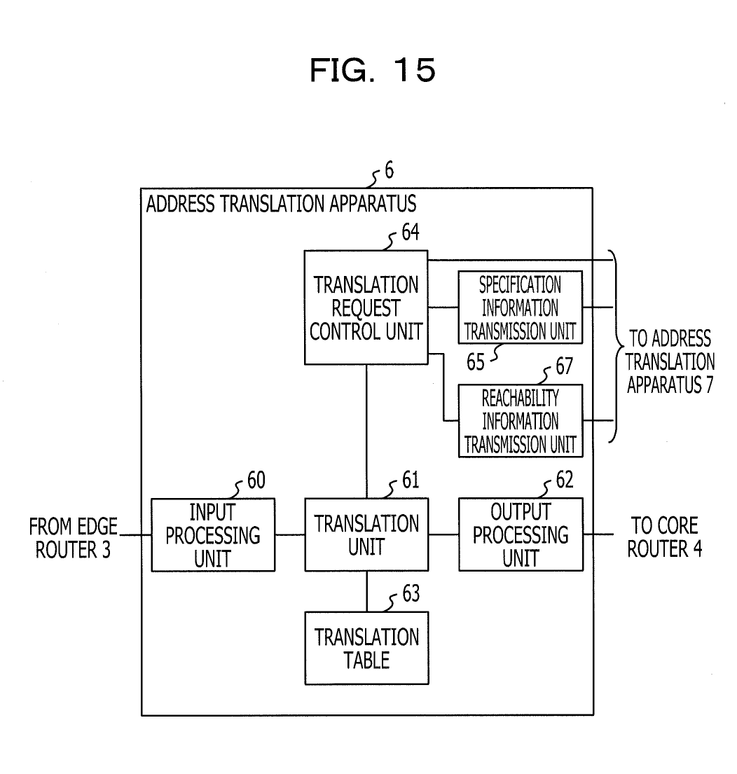

FIG. 15 is a diagram illustrating a third example of a functional configuration of the first address translation apparatus 6. The first address translation apparatus 6 includes a reachability information transmission unit 67. The translation request control unit 64 notifies the reachability information transmission unit 67 of private addresses to be translated by the second address translation apparatus 7. The reachability information transmission unit 67 creates path information as reachability information on the basis of a private address and a global address of the edge router 3, for making it possible for a response packet output in response to a packet whose source address is to be translated by the second address translation apparatus 7 to reach the edge router 3. The reachability information transmission unit 67 transmits the reachability information to the core router 4 or the second address translation apparatus 7.

The reachability information transmission unit 67 may, for example, transmit the reachability information every time the translation request control unit 64 requests the second address translation apparatus 7 to execute the translation process. In addition, the reachability information transmission unit 67 may, for example, notify the second address translation apparatus 7 of the reachability information at a time that is not relevant to the request for the translation process. The reachability information transmission unit 67 may notify the second address translation apparatus 7 of the path information that covers from a private address to be translated by the second address translation apparatus 7 to the edge router 3b in accordance with, for example, a routing protocol such as Open Shortest Path First (OSPF). However, the core router 4 or the second address translation apparatus 7 that has received the path information does not distribute the received path information to another node apparatus any more.

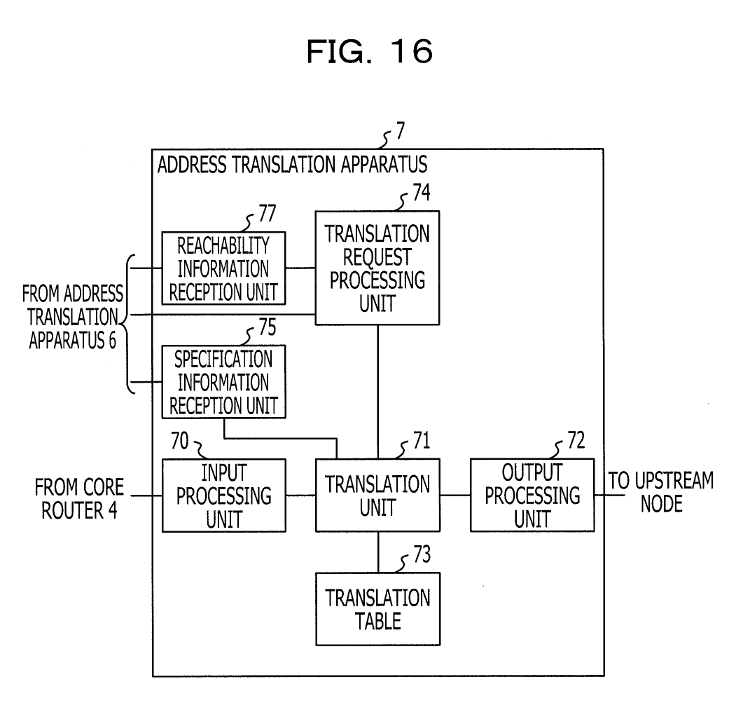

FIG. 16 is a diagram illustrating a third example of a functional configuration of the second address translation apparatus 7. The second address translation apparatus 7 includes a reachability information reception unit 77. The reachability information reception unit 77 transmits the reachability information received from the first address translation apparatus 6 to the translation request processing unit 74. The translation request processing unit 74 transmits the reachability information to the core router 4. When the core router 4 has received the reachability information from the translation request processing unit 74 or the first address translation apparatus 6, the routing processing unit 51 in the core router 4 registers path information based on the reachability information to the routing table 52.

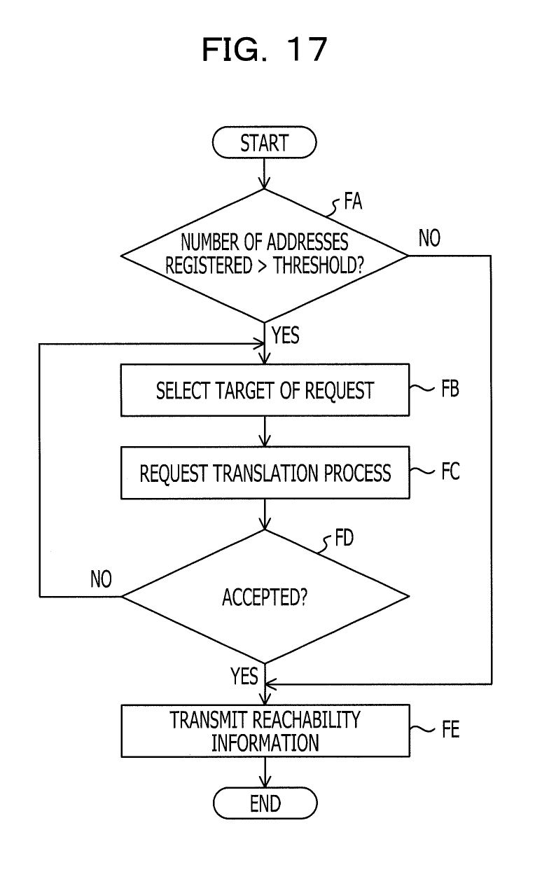

FIG. 17 is a diagram illustrating a second example of a process executed by the first address translation apparatus 6 to request the translation process. Processing in FA to FD is the same as that in AA to AD illustrated in FIG. 8.

In FE, the reachability information transmission unit 67 creates reachability information and transmits the reachability information to the core router 4 or the second address translation apparatus 7.

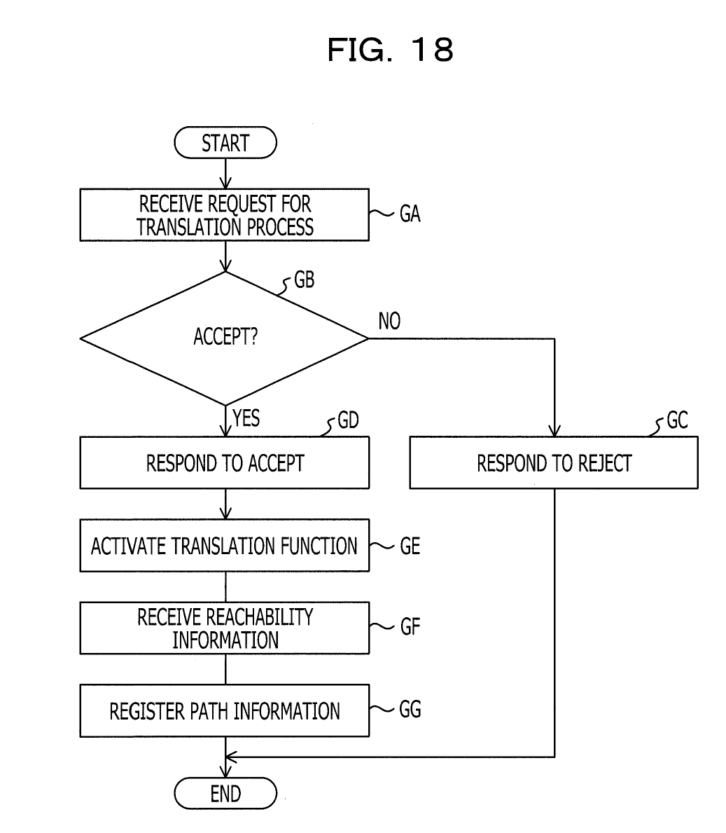

FIG. 18 is a diagram illustrating a second example of a process executed by the second address translation apparatus 7 when the translation process has been requested. Processing in GA to GE is the same as that in BA to BE illustrated in FIG. 9.

In GF, the reachability information reception unit 77 receives, the reachability information transmitted from the first address translation apparatus 6. The reachability information reception unit 77 transmits the reachability information to the translation request processing unit 74.

In GG, the translation request processing unit 74 transmits the reachability information to the core router 4. Thereafter, the routing processing unit 51 registers the path information based on the reachability information to the routing table 52.

According to this embodiment, it is possible for a response packet output in response to a packet whose source address has been translated by the second address translation apparatus 7 to reach the edge router 3 through the core network 2.

### 4. Fourth Embodiment

Next, a fourth embodiment will be described. In this embodiment, the first address translation apparatus 6 causes the second address translation apparatus 7 to execute the translation of private addresses only for some of the addresses specified by the specification information. For example, in a certain embodiment, whether the first address translation apparatus 6 or the second address translation apparatus 7 executes the address translation may be determined for each flow, that is, for each IP address assigned to a user. Components and functions thereof included in this embodiment may be included in other embodiments that will be described later.

For example, suppose that a global address 1.1.1.1 is shared by eight users having private IP addresses 10.0.0.1 to 10.0.0.8, respectively. When the users having the private IP addresses 10.0.0.1 to 10.0.0.4, respectively, momentarily occupy most of the ports of the global address, the ports for the users having the private IP address 10.0.0.5 to 10.0.0.8, respectively, may undesirably run short.

In this case, the address range of the private IP addresses 10.0.0.1 to 10.0.0.8 is transmitted to the second address translation apparatus 7 in advance in the form of the specification information. Next, for example, the flows of the source IP addresses 10.0.0.1 to 10.0.0.4 are translated by the first address translation apparatus 6, and the flows of the source IP addresses 10.0.0.5 to 10.0.0.8 are translated by the second address translation apparatus 7. Otherwise, for example, the flows of the source IP addresses 10.0.0.1 to 10.0.0.4 are translated by the second address translation apparatus 7, and the flows of the source IP addresses 10.0.0.5 to 10.0.0.8 are translated by the first address translation apparatus 6.

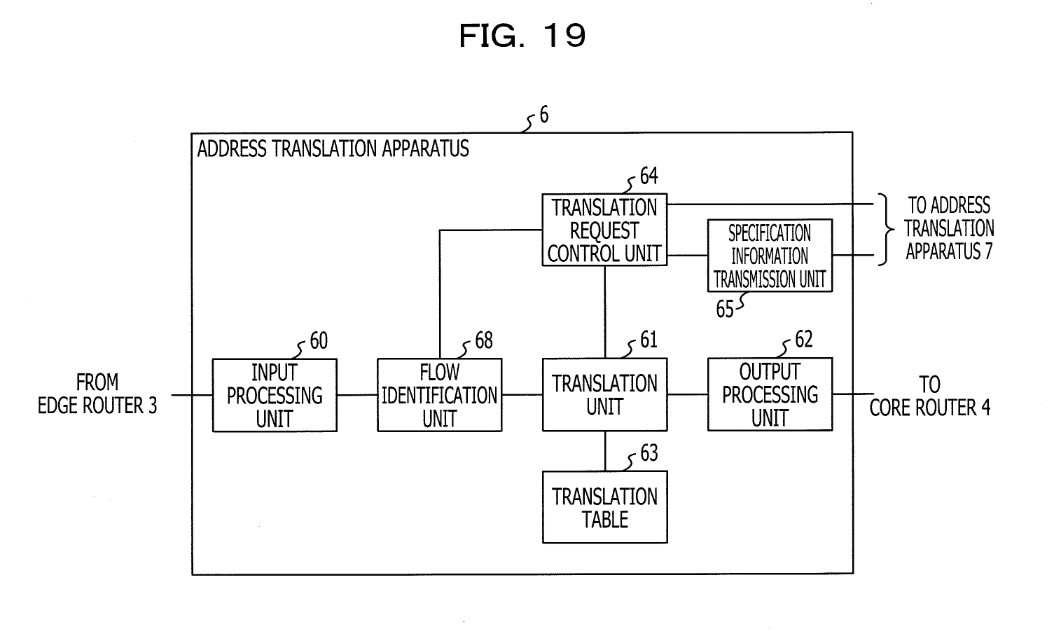

FIG. 19 is a diagram illustrating a fourth example of a functional configuration of the first address translation apparatus 6. The first address translation apparatus 6 includes a flow identification unit 68. The translation request control unit 64 transmits, to the flow identification unit 68, the setting of flows for which the private addresses are to be translated by the second address translation apparatus 7. The flow identification unit 68 determines whether or not to translate the private address by the second address translation apparatus 7 for each input packet in accordance with the setting of flows. When the flow identification unit 68 determines that the addresses are not to be translated by the second address translation apparatus 7 for the flow, the translation unit 61 translates the source address of the input packet into a global address.

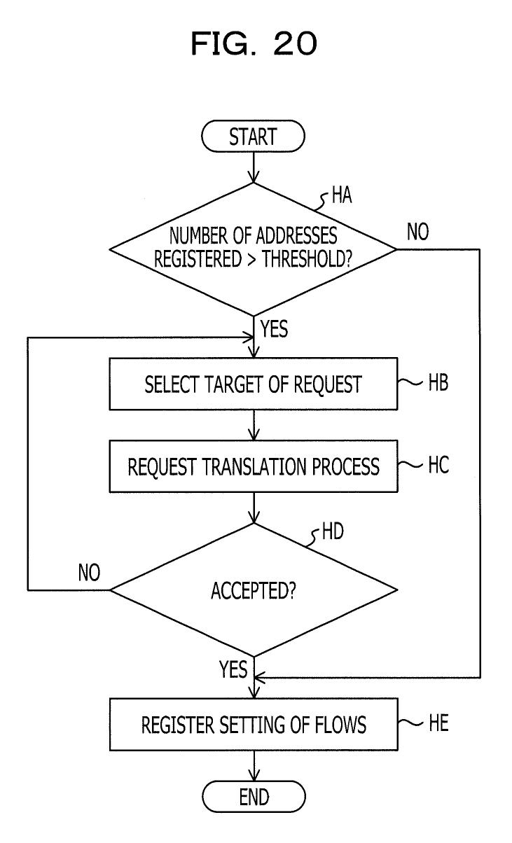

FIG. 20 is a diagram illustrating a third example of a process executed by the first address translation apparatus 6 to request the translation process. Processing in HA to HD is the same as that in AA to AD illustrated in FIG. 8.

In HE, when it is determined in HD that the response from the second address translation apparatus 7 indicates acceptance of the request (YES in HD), the translation request control unit 64 transmits, to the flow identification unit 68, the setting of flows for which the private addresses are to be translated by the second address translation apparatus 7.

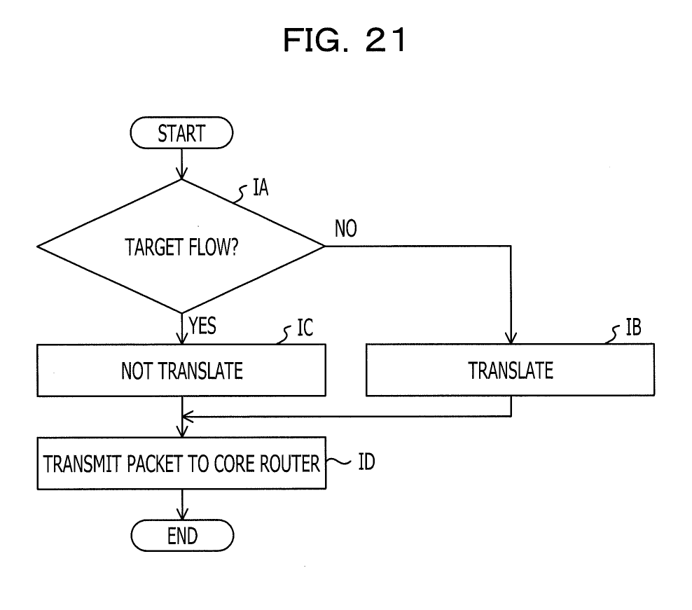

FIG. 21 is a diagram illustrating a third example of a process executed by the first address translation apparatus 6 to process a packet.

In IA, the flow identification unit 68 determines whether or not an input packet is a target of the address translation executed by the second address translation apparatus 7 in accordance with the setting of flows made by the translation request control unit 64. When the input packet is not a target of the address translation executed by the second address translation apparatus 7 (NO in IA), the process proceeds to IB. When the input packet is a target of the address translation executed by the second address translation apparatus 7 (YES in IA), the process proceeds to IC. The processing in IB to ID is the same as that in CB to CD illustrated in FIG. 10.

In another embodiment, the translation unit 61 determines whether or not addresses specified by the specification information may be subjected to the address translation. When it is determined that the process for translating an address is not possible, the translation unit 61 may cause the second address translation apparatus 7 to execute the process for translating an address instead. For example, the translation unit 61 may determine whether or not unused global addresses used to translate the source addresses of input packets would run short. When unused global addresses would run short, the translation unit 61 may cause the second address translation apparatus 7 to execute the process for translating an address instead.

In another embodiment, the translation unit 61 may determine whether or not the address translation is possible for a packet that has been determined by the flow identification unit 68 to be a target flow. When it is determined that the process for translating an address is not possible, the translation unit 61 may cause the second address translation apparatus 7 to execute the process for translating an address instead. When it is determined that the process for translating an address is possible, the translation unit 61 may execute the process for translating an address.

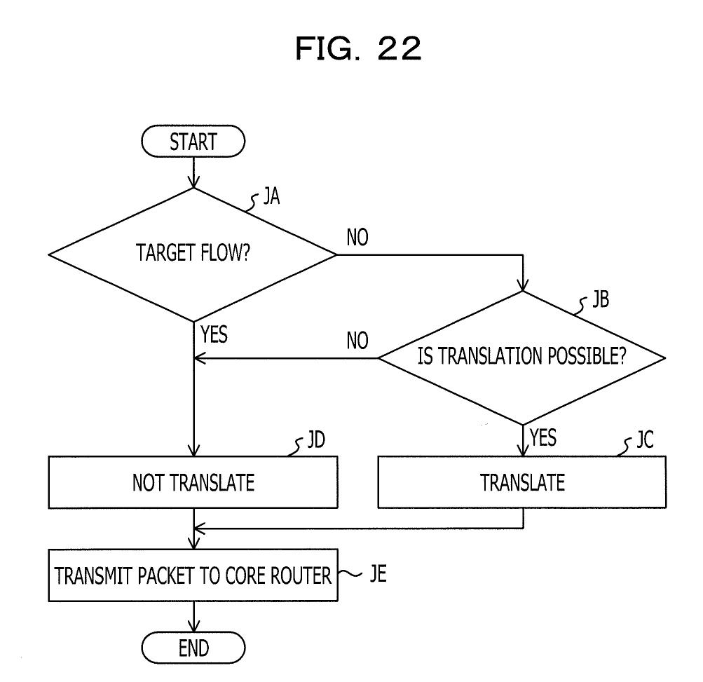

FIG. 22 is a diagram illustrating a fourth example of a process executed by the first address translation apparatus 6 to process a packet.

In JA, the flow identification unit 68 determines whether or not an input packet is a target of the address translation executed by the second address translation apparatus 7. When the input packet is not a target of the address translation executed by the second address translation apparatus 7 (NO in JA), the process proceeds to JB. When the input packet is a target of the address translation executed by the second address translation apparatus 7 (YES in JA), the process proceeds to JD.

In JB, the translation unit 61 determines whether or not the source address of the input packet may be translated. When the address translation is possible (YES in JB), the process proceeds to JC. When the address translation is not possible (NO in JB), the process proceeds to JD. The processing in JC to JE is the same as that in CB to CD illustrated in FIG. 10.

According to this embodiment, the first address translation apparatus 6 may dynamically change which address is to be translated by the second address translation apparatus 7 in the range of addresses specified by the specification information that has been transmitted in the past. Therefore, the first address translation apparatus 6 may change the range of private addresses to be translated by the second address translation apparatus 7 more easily, for example, in accordance with changes in the number of global addresses used.

### 5. Fifth Embodiment

Next, a fifth embodiment will be described. As illustrated in FIG. 1, when the single edge router 3a is connected to the plurality of core routers 4a and 4b, packets are forwarded to either core router through a shortest path obtained by a path search. Therefore, in this embodiment, the first address translation apparatus 6a, which executes the address translation on the packets forwarded by the edge router 3a, requests both the second address translation apparatuses 7a and 7b, which execute the address translation on the packets received from the edge router 3a by the core routers 4a and 4b, respectively, to execute the process for translating an address.

After receiving responses from the second address translation apparatuses 7a and 7b in response to the request for the process for translating an address, the translation request control unit 64 notifies the routing processing unit 51 in the edge router 3a of the second address translation apparatus 7 that has accepted the request.

When the plurality of second address translation apparatuses 7a and 7b accept the requests, the routing processing unit 51 determines the core router 4 to which the packet is to be forwarded in accordance with a shortest path obtained by a path search, from the plurality of core routers 4a and 4b that have accepted the requests. As a result, the process for translating an address is executed by the second address translation apparatus 7 provided for the core router 4 to which the packets are to be forwarded, which has been obtained by the path search. For example, when the core router 4a is obtained by the path search as a destination to which the packet is to be forwarded, the second address translation apparatus 7a, which has been provided to translate the addresses of the packets received by the core router 4a, executes the process for translating an address.

When one of the plurality of second address translation apparatuses 7a and 7b rejects the request, the routing processing unit 51 determines the core router 4 for which the other second address translation apparatus 7 that has accepted the request has been provided to be a destination to which the packet is to be forwarded. For example, when the second address translation apparatus 7a rejects the request, the routing processing unit 51 determines the core router 4b as the destination of the packet, and the second address translation apparatus 7b executes the process for translating an address.

According to this embodiment, when there are a plurality of core routers 4 located adjacent to a single edge router 3, it is possible to determine a second address translation apparatus 7 that executes the address translation. Components and functions thereof included in this embodiment may be included in other embodiments that will be described later.

### 6. Sixth Embodiment

Next, a sixth embodiment will be described. In this embodiment, when the plurality of core routers 4a and 4b are connected to the single edge router 3a, priority is established in advance between the second address translation apparatuses 7a and 7b that translate the addresses of packets forwarded by the core routers 4a and 4b. The first address translation apparatus 6a that translates an address of a packet forwarded by the edge router 3a selects a second address translation apparatus 7 to which a request for the process for translating an address is transmitted in accordance with the priority. The translation request control unit 64 determines a second address translation apparatus 7 that has accepted the request first as the second address translation apparatus 7 that executes the address translation. Components and functions thereof included in this embodiment may be included in other embodiments that will be described later.

According to this embodiment, when a plurality of core routers 4 are connected to a single edge router 3, not all second address translation apparatuses 7 provided for the core routers 4 have to be requested to execute the process for translating an address. Therefore, the number of times the process for requesting the process for translating an address is executed is reduced, and the amount of processing executed by first address translation apparatuses 6 and the second address translation apparatuses 7 is reduced.

### 7. Seventh Embodiment

Next, a seventh embodiment will be described. In this embodiment, the second address translation apparatus 7 regularly notifies the first address translation apparatus 6 of the number of unused global addresses that may be used by the second address translation apparatus 7 for the address translation. In the following description, information regarding the number of unused global addresses that may be used by the second address translation apparatus 7 for the address translation will be referred to as “available resource information”. The first address translation apparatus 6 selects one of a plurality of second address translation apparatuses 7 on the basis of the available resource information received from each of the plurality of second address translation apparatuses 7, and requests the selected second address translation apparatus 7 to execute the process for translating an address. Components and functions thereof included in this embodiment may be included in another embodiment that will be described later.

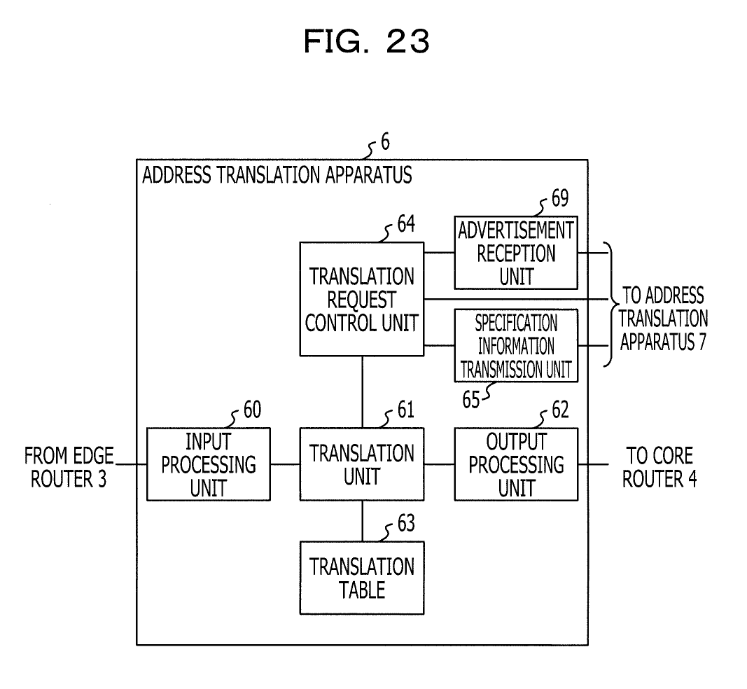

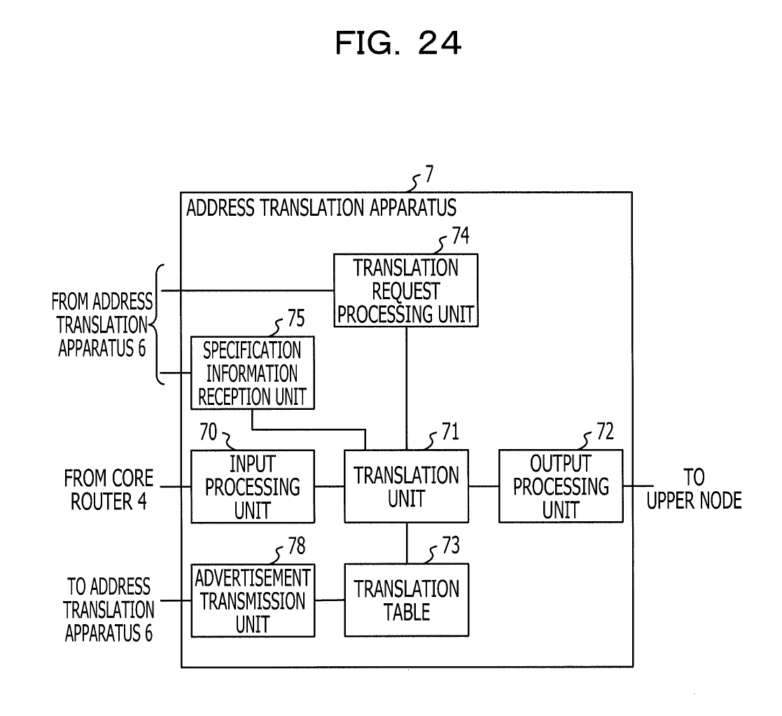

FIG. 23 is a diagram illustrating a fifth example of a functional configuration of the first address translation apparatus 6. The first address translation apparatus 6 includes an advertisement reception unit 69. FIG. 24 is a diagram illustrating a fourth example of a functional configuration of the second address translation apparatus 7. The second address translation apparatus 7 includes an advertisement transmission unit 78. The advertisement transmission unit 78 creates available resource information on the basis of global addresses in use that have been registered to the translation table 73, and regularly notifies the first address translation apparatus 6 of the available resource information.

The advertisement reception unit 69 receives the available resource information and transmits the available resource information to the translation request control unit 64. The translation request control unit 64 requests a second address translation apparatus 7 that has an available unused global address to execute the process for translating an address, on the basis of the available resource information.

According to this embodiment, when a plurality of core routers 4 are connected to a single edge router 3, not all second address translation apparatuses 7 provided for the core routers 4 have to be requested to execute the process for translating an address. Therefore, the number of times the process for requesting the process for translating an address is executed is reduced, and the amount of processing executed by first address translation apparatuses 6 and the second address translation apparatuses 7 is reduced.

### 8. Eighth Embodiment

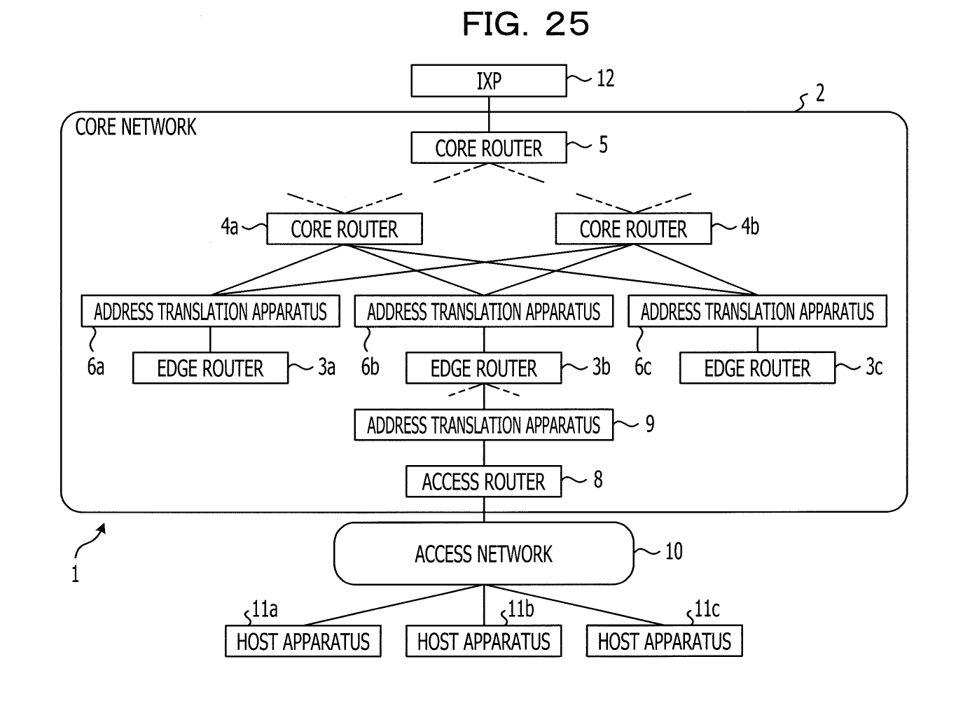

Next, an eighth embodiment will be described. FIG. 25 is a diagram illustrating a second example of a configuration of the communication system 1. The communication system 1 includes an access router 8 that gathers lines connecting from the access network 10 to the edge router 3b together. The access router 8 is an example of a third forwarding apparatus.

The communication system 1 includes a third address translation apparatus 9. The third address translation apparatus 9 may be realized as hardware separate from the access router 8 or as hardware integrated with the access router 8. The third address translation apparatus 9 translates, from addresses on the access network 10 into addresses on the core network 2, the source addresses of packets transmitted by the access router 8 to the edge routers 3a to 3c, in accordance with requests output from the first address translation apparatuses 6a to 6c.

In the first to seventh embodiments, the process for translating an address concerning private addresses and global addresses is executed by the second address translation apparatus 7 that translates the address of a packet forwarded by the core router 4 as an upstream node of the edge router 3. In this embodiment, instead of this or in addition to this, the process for translating an address is executed by the third address translation apparatus 9 that translates the address of a packet forwarded by the access router 8 at a downstream node of the edge router 3. The configuration of the third address translation apparatus 9 and the process executed by the third address translation apparatus 9 may be the same as the configuration of the second address translation apparatus 7 and the process executed by the second address translation apparatus 7, respectively.

According to this embodiment, the process for translating an address executed at the position of the edge router 3 is also executed at the position of an adjacent access router 8 along a path from the edge router 3 in a distributed manner. By executing the address translation in components other than the edge router 3 and therefore by increasing the number of addresses that may be translated, it is possible to reduce the number of edge routers 3 to be newly provided relative to an increase in the number of global addresses used. In addition, by executing the process for translating an address concerning private addresses and global addresses at the positions of both the core router 4 and the access router 8, the range of distribution of the translation process may be further expanded.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An address translation apparatus for translating an address included in a packet to relay the packet, the packet being transmitted between an external network and an internal network, the address translation apparatus comprising:
a processor to
receive a packet transmitted from the internal network,
determine, based on a given condition, whether to perform address translation on the received packet,
translate, upon determining to perform address translation, a source address of the received packet from an internal address into an external address to obtain a translated packet and relay the translated packet, and
relay, upon determining not to perform address translation, the received packet to an alternate translation apparatus without performing address translation.

2. The address translation apparatus according to claim 1, wherein
the processor transmits, upon determining not to perform address translation, a request for performing address translation on the received packet to the alternate translation apparatus.

3. The address translation apparatus according to claim 2, wherein
the processor transmits, when transmitting the request to the alternate translation apparatus, specification information to the alternate translation apparatus, the specification information specifying one or more addresses to be translated.

4. The address translation apparatus according to claim 2, wherein
the processor adds, when transmitting the request to the alternate translation apparatus, a given identifier to the relayed packet.

5. The address translation apparatus according to claim 2, wherein
the processor transmits reachability information to the alternate translation apparatus when transmitting the request to the alternate translation apparatus, the reachability information being used for transferring a response packet to the address translation apparatus, the response packet being transmitted in response to a packet having as a source address an external address translated from the internal address by the alternate translation apparatus.

6. The address translation apparatus according to claim 2, wherein
the processor registers, in a storage device, internal addresses to be translated by the address translation apparatus, and
the given condition relates to a total number of the internal addresses registered in the storage device.

7. The address translation apparatus according to claim 3, wherein
the source address is included in the one or more addresses specified by the specification information.

8. The address translation apparatus according to claim 7, wherein
the processor determines an address to be translated from among the addresses specified by the specification information for each flow.

9. The address translation apparatus according to claim 2, wherein
the processor transmits, when transmitting the request to the alternate translation apparatus, the request to a plurality of address translation apparatuses, and
the processor selects, upon receiving affirmative responses from some address translation apparatuses, one apparatus among the some address translation apparatuses as the alternate translation apparatus, the one apparatus being an address translation apparatus which has been determined to be a destination of the received packet by a path search.

10. The address translation apparatus according to claim 2, wherein
the processor selects the alternate translation apparatus from among a plurality of address translation apparatuses in accordance with given priority ordering defined in advance for the plurality of address translation apparatuses.

11. The address translation apparatus according to claim 2, wherein
the processor selects the alternate translation apparatus from among a plurality of address translation apparatuses, based on respective numbers of external addresses available for address translation in the plurality of address translation apparatuses.

12. An address translation apparatus for translating an address included in a packet to relay the packet, the packet being transmitted between an external network and an internal network, the address translation apparatus comprising:
a processor to
receive a packet relayed from a preceding translation apparatus,
translate, upon receiving a request for performing address translation from the preceding translation apparatus, a source address of the received packet from an internal address into an external address to obtain a translated packet, and
relay the translated packet.

13. The address translation apparatus according to claim 12, wherein
the processor receives specification information from the preceding translation apparatus, the specification information specifying one or more internal addresses, and
the source address is included in the one or more internal addresses specified by the specification information.

14. The address translation apparatus according to claim 12, wherein
the processor translates the source address into the external address when the processor detects a given identifier added to the received packet.

15. The address translation apparatus according to claim 12, wherein
the processor receives reachability information from the preceding translation apparatus, the reachability information being used for transferring a response packet to the preceding translation apparatus, the response packet being transmitted in response to a packet having as a source address an external address translated from the internal address by the address translation apparatus, and
the processor determines a destination of the response packet in accordance with the reachability information.

16. An address translation apparatus for translating an address included in a packet to relay the packet, the packet being transmitted between an external network and an internal network, the address translation apparatus comprising:
a processor to
receive a packet transmitted from the internal network,
translate, upon receiving from a subsequent translation apparatus a request for performing address translation, a source address of the received packet from an internal address into an external address to obtain a translated packet, and
relay the translated packet to the subsequent translation apparatus.

17. The address translation apparatus according to claim 16, wherein
the processor receives specification information from the subsequent translation apparatus, the specification information specifying one or more internal addresses, and
the source address is included in the one or more internal addresses specified by the specification information.

18. A communication system for translating an address included in a packet to relay the packet, the packet being transmitted between an external network and an internal network, the communication system comprising:
a first address translation apparatus including a first processor to
receive a first packet transmitted from the internal network,
determine, based on a given condition, whether to perform address translation on the first packet,
translate, upon determining to perform address translation, a source address of the first packet from an internal address into a first external address to obtain a second packet and relay the second packet instead of the first packet, and
relay, upon determining not to perform address translation, the first packet without performing address translation; and
a second address translation apparatus including a second processor to
receive the first packet from the first address translation apparatus,
translate the source address of the first packet from the internal address into a second external address to obtain a third packet, and relay the third packet instead of the first packet.

19. A computer-readable recording medium storing a program that causes a computer to execute an address translation method for translating an address included in a packet to relay the packet, the packet being transmitted between an external network and an internal network, the address translation method comprising:
receiving a packet transmitted from the internal network;
determining, based on a given condition, whether to perform address translation on the received packet;
translating, upon determining to perform address translation, a source address of the received packet from an internal address into an external address to obtain a translated packet and relaying the translated packet; and
relaying, upon determining not to perform address translation, the received packet to an alternate translation apparatus without performing address translation.

20. An address translation method executed by an address translation apparatus for translating an address included in a packet to relay the packet, the packet being transmitted between an external network and an internal network, the address translation method comprising:
receiving, by the address translation apparatus, a packet transmitted from the internal network;
determining, based on a given condition, whether to perform address translation on the received packet;
translating, upon determining to perform address translation, a source address of the received packet from an internal address into an external address to obtain a translated packet and relaying the translated packet; and
relaying, upon determining not to perform address translation, the received packet to an alternate translation apparatus without performing address translation.
